(19) United States
(12) Patent Application Publication
(10) Pub. No.: US 2023/0158892 A1
(43) Pub. Date: May 25, 2023

(54) CONTROL METHOD AND SYSTEM FOR BRAKING BACKUP IN AUTONOMOUS DRIVING

(71) Applicant: NIO TECHNOLOGY (ANHUI) CO., LTD, Hefei City (CN)

(72) Inventors: Xianhui ZHANG, Shanghai (CN); Danilo TEOBALDI, Shanghai (CN); Bohong XIAO, Shanghai (CN); Da YUAN, Shanghai (CN); Tong ZHANG, Shanghai (CN); Baotian WANG, Shanghai (CN)

(21) Appl. No.: 18/058,346

(22) Filed: Nov. 23, 2022

(30) Foreign Application Priority Data
Nov. 23, 2021 (CN) 202111393666.4

(51) Int. Cl. B60L 7/26; B60T 7/12; B60T 8/1755; B60T 8/92

(52) U.S. Cl. CPC B60L 7/26; B60T 7/12; B60T 8/1755; B60T 8/92; B60T 2270/402; B60T 2270/603

(57) ABSTRACT

The disclosure relates to a control method and system for braking backup in autonomous driving, a computer storage medium, a computer device, and a vehicle. The control method for braking backup in autonomous driving according to an aspect of the disclosure includes: receiving a status indication of an execution module associated with braking and a status indication of a function module associated with stability control; determining, based at least in part on the received status indication of the execution module associated with braking and the received status indication of the function module associated with stability control, a braking capability of the execution module associated with braking; and assigning a braking command based at least in part on the received status indication of the execution module associated with braking and the determined braking capability of the execution module associated with braking.

### CROSS-REFERENCE TO RELATED APPLICATIONS

This application claims the benefit of China Patent Application No. 202111393666.4 filed Nov. 23, 2021, the entire contents of which are incorporated herein by reference in its entirety.

### TECHNICAL FIELD

The disclosure relates to the field of vehicle control, and more specifically, to a control method and system for braking backup in autonomous driving, a computer storage medium, a computer device, and a vehicle.

### BACKGROUND

As people constantly pursue safe and comfortable driving experience, autonomous driving technologies have become a new development trend of automobiles. The autonomous driving technologies rely on collaboration of computer vision, radars, monitoring apparatuses, global positioning systems, etc., to enable operations such as autonomous driving, steering, and braking of vehicles without active intervention of humans.

In the process of autonomous driving control, since an autonomous driving system completely controls a vehicle, there are very high safety requirements for the vehicle control, especially for safety requirements for a braking system. At present, a commonly used method for ensuring the safety of the braking system is to add hardware to the vehicle and use a dual-line braking system at the same time, so as to ensure that the braking is not lost. However, this method has a high cost and difficult in arrangement, and the same braking lines cannot be controlled completely independently of each other. In addition, a vehicle not installed with any dual-line braking system is difficult to upgrade to be equipped with a braking system with advanced autonomous driving capabilities.

### BRIEF SUMMARY

In order to solve or at least alleviate one or more of the above problems, the following technical solutions are provided.

According to a first aspect of the disclosure, there is provided a control method for braking backup in autonomous driving, including: receiving a status indication of an execution module associated with braking and a status indication of a function module associated with stability control; determining, based at least in part on the received status indication of the execution module associated with braking and the received status indication of the function module associated with stability control, a braking capability of the execution module associated with braking; and assigning a braking command based at least in part on the received status indication of the execution module associated with braking and the determined braking capability of the execution module associated with braking.

The control method for braking backup in autonomous driving according to an embodiment of the disclosure further includes: performing vehicle stability control based at least in part on the received status indication of the execution module associated with braking.

In the control method for braking backup in autonomous driving according to an embodiment of the disclosure or any of the above embodiments, the execution module associated with braking includes one or more of the following: a hydraulic braking module, a motor torque response module, and an electronic parking module.

In the control method for braking backup in autonomous driving according to an embodiment of the disclosure or any of the above embodiments, the determined braking capability of the execution module associated with braking includes one or more of the following: a hydraulic braking torque capability, a negative motor torque capability, and dynamic clamping braking torque.

In the control method for braking backup in autonomous driving according to an embodiment of the disclosure or any of the above embodiments, the assigning a braking command based at least in part on the received status indication of the execution module associated with braking and the determined braking capability of the execution module associated with braking further includes: instructing, in response to the received status indication of the execution module associated with braking, the hydraulic braking module to be in a first state to perform braking using negative motor torque, wherein hydraulic braking torque is used for the braking when the negative motor torque is insufficient.

In the control method for braking backup in autonomous driving according to an embodiment of the disclosure or any of the above embodiments, the assigning a braking command based at least in part on the received status indication of the execution module associated with braking and the determined braking capability of the execution module associated with braking further includes: instructing, in response to the received status indication of the execution module associated with braking, the hydraulic braking module to be in a second state to perform braking using hydraulic braking torque.

In the control method for braking backup in autonomous driving according to an embodiment of the disclosure or any of the above embodiments, the assigning a braking command based at least in part on the received status indication of the execution module associated with braking and the determined braking capability of the execution module associated with braking further includes: instructing, in response to the received status indication of the execution module associated with braking, the hydraulic braking module to be in a third state to perform braking using negative motor torque, where dynamic clamping braking torque is used for the braking when the negative motor torque is insufficient.

In the control method for braking backup in autonomous driving according to an embodiment of the disclosure or any of the above embodiments, the performing vehicle stability control based at least in part on the received status indication of the execution module associated with braking further includes: instructing, in response to the received status indication of the execution module associated with braking, the hydraulic braking module to be in a first state to control hydraulic braking torque and negative motor torque using the function module associated with stability control in the hydraulic braking module.

In the control method for braking backup in autonomous driving according to an embodiment of the disclosure or any of the above embodiments, the performing vehicle stability control based at least in part on the received status indication of the execution module associated with braking further includes: instructing, in response to the received status indication of the execution module associated with braking, the hydraulic braking module to be in a second state to control hydraulic braking torque using the function module associated with stability control in a vehicle control unit.

In the control method for braking backup in autonomous driving according to an embodiment of the disclosure or any of the above embodiments, the performing vehicle stability control based at least in part on the received status indication of the execution module associated with braking further includes: instructing, in response to the received status indication of the execution module associated with braking, the hydraulic braking module to be in a third state to control negative motor torque and an anti-lock sub-module in an electronic parking module using the function module associated with stability control in a vehicle control unit.

According to a second aspect of the disclosure, there is provided a control system for braking backup in autonomous driving, including: a receiving unit configured to receive a status indication of an execution module associated with braking and a status indication of a function module associated with stability control; a determining unit configured to determine, based at least in part on the received status indication of the execution module associated with braking and the received status indication of the function module associated with stability control, a braking capability of the execution module associated with braking; and an assignment unit configured to assign a braking command based at least in part on the received status indication of the execution module associated with braking and the determined braking capability of the execution module associated with braking.

The control system for braking backup in autonomous driving according to an embodiment of the disclosure further includes: a stability control unit configured to perform vehicle stability control based at least in part on the received status indication of the execution module associated with braking.

In the control system for braking backup in autonomous driving according to an embodiment of the disclosure or any of the above embodiments, the assignment unit is further configured to instruct, in response to the received status indication of the execution module associated with braking, the hydraulic braking module to be in a first state to perform braking using negative motor torque, where hydraulic braking torque is used for the braking when the negative motor torque is insufficient.

In the control system for braking backup in autonomous driving according to an embodiment of the disclosure or any of the above embodiments, the assignment unit is further configured to instruct, in response to the received status indication of the execution module associated with braking, the hydraulic braking module to be in a second state to perform braking using hydraulic braking torque.

In the control system for braking backup in autonomous driving according to an embodiment of the disclosure or any of the above embodiments, the assignment unit is further configured to instruct, in response to the received status indication of the execution module associated with braking, the hydraulic braking module to be in a third state to perform braking using negative motor torque, where dynamic clamping braking torque is used for the braking when the negative motor torque is insufficient.

In the control system for braking backup in autonomous driving according to an embodiment of the disclosure or any of the above embodiments, the stability control unit is further configured to instruct, in response to the received status indication of the execution module associated with braking, the hydraulic braking module to be in a first state to control hydraulic braking torque and negative motor torque using the function module associated with stability control in the hydraulic braking module.

In the control system for braking backup in autonomous driving according to an embodiment of the disclosure or any of the above embodiments, the stability control unit is further configured to instruct, in response to the received status indication of the execution module associated with braking, the hydraulic braking module to be in a second state to control hydraulic braking torque using the function module associated with stability control in a vehicle control unit.

In the control system for braking backup in autonomous driving according to an embodiment of the disclosure or any of the above embodiments, the stability control unit is further configured to instruct, in response to the received status indication of the execution module associated with braking, the hydraulic braking module to be in a third state to control negative motor torque and an anti-lock sub-module in an electronic parking module using the function module associated with stability control in a vehicle control unit.

According to a third aspect of the disclosure, there is provided a computer storage medium including instructions, where when the instructions are run, the steps of the control method for braking backup in autonomous driving according to the first aspect of the disclosure are performed.

According to a fourth aspect of the disclosure, there is provided a computer device including a memory, a processor, and a computer program stored on the memory and executable on the processor, where when the processor executes the computer program, the steps of the control method for braking backup in autonomous driving according to the first aspect of the disclosure are implemented.

According to a fifth aspect of the disclosure, there is provided a vehicle including the control system for braking backup in autonomous driving according to the second aspect of the disclosure.

According to the control solutions for braking backup in autonomous driving in one or more embodiments of the disclosure, braking redundancy can be provided for an autonomous vehicle when the autonomous vehicle is braked, braking stability can be ensured, and a braking failure rate can be reduced, thereby improving safety performance of a braking system in autonomous driving.

### BRIEF DESCRIPTION OF THE SEVERAL VIEWS OF THE DRAWINGS

The above-mentioned and/or other aspects and advantages of the disclosure will become more apparent and more readily appreciated from the following description of various aspects in conjunction with the accompanying drawings, in which the same or similar units are denoted by the same reference numerals. In the accompanying drawings:

FIG. 1 is a flowchart of a control method for braking backup in autonomous driving according to an embodiment of the disclosure;

FIG. 2 is a schematic diagram of a control system for braking backup in autonomous driving according to an embodiment of the disclosure; and

FIG. 3 is a block diagram of a computer device according to an embodiment of the disclosure.

### DETAILED DESCRIPTION

The following descriptions of the specific embodiments are merely exemplary in nature, and are not intended to limit the disclosed technologies or the application and use of the disclosed technologies. In addition, there is no intention to be bound by any expressed or implied theory presented in the foregoing Technical Field and Background Art, or the following Detailed Description.

In the following detailed descriptions of the embodiments, many specific details are set forth to provide a more thorough understanding of the disclosed technologies. However, it is obvious for those of ordinary skill in the art that the disclosed technologies may be practiced without these specific details. In other instances, well-known features are not detailed, to avoid complicating the descriptions unnecessarily.

The terms such as “include” and “comprise” are used to indicate that in addition to the units and steps that are directly and clearly described in this specification, other units and steps that are not directly or clearly described are not excluded in the technical solutions of the disclosure. The terms such as “first” and “second” are not used to indicate sequences of units in terms of time, space, size, etc., and are merely used to distinguish between the units.

It should be noted that, in the context of the disclosure, the terms such as “execution module associated with braking” includes, but is not limited to, a hydraulic braking module, a motor torque response module, and an electronic parking module. The term “function module associated with stability control” includes, but is not limited to, an anti-lock (ABS) module, a dragging torque control (DTC) module, and a dynamic clamping (RWU) function module.

Various exemplary embodiments according to the disclosure will be described below in detail with reference to the accompanying drawings.

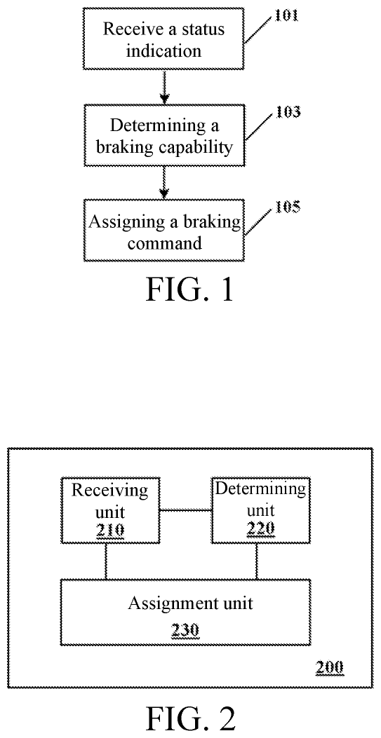

FIG. 1 is a flowchart of a control method for braking backup in autonomous driving according to an embodiment of the disclosure.

As shown in FIG. 1, in step 101, a status indication of an execution module associated with braking and a status indication of a function module associated with stability control are received.

In an embodiment, the status indication of the execution module associated with braking may include, but is not limited to, a motor status indication, a braking torque status indication, and an electronic parking status indication, where the motor status indication, the braking torque status indication, and the electronic parking status indication may indicate whether the corresponding execution module associated with braking is in a normal state, a degraded state, or a failure state. In an embodiment, the status indication of the function module associated with stability control may include, but is not limited to, an anti-lock (ABS) module status indication, a dragging torque control (DTC) module status indication, and a dynamic clamping (RWU) function module status indication, where the anti-lock (ABS) module status indication, the dragging torque control (DTC) module status indication, and the dynamic clamping (RWU) function module status indication may indicate whether the corresponding function module associated with stability control is in a normal state, a degraded state, or a failure state. It can be understood that the status indication of the execution module associated with braking and the status indication of the function module associated with stability control above may be respectively reported by the execution module associated with braking and the function module associated with stability control periodically to represent respective states thereof.

In an embodiment, the status indication of the execution module associated with braking, the status indication of the function module associated with stability control, and status indications of various sensors in autonomous driving are received to determine whether the execution module associated with braking, the function module associated with stability control, and the various sensors in autonomous driving are available. As an example, the sensors may include, but are not limited to, a wheel speed sensor, an inertial sensor, a pressure sensor, a motor wheel speed sensor, an actual motor torque estimation module, and a battery charging limit estimation module.

In step 103, a braking capability of the execution module associated with braking is determined based at least in part on the received status indication of the execution module associated with braking and the received status indication of the function module associated with stability control, where the determined braking capability of the execution module associated with braking includes, but is not limited to, a hydraulic braking torque capability, a negative motor torque capability, and dynamic clamping braking torque.

In step 105, a braking command is assigned based at least in part on the received status indication of the execution module associated with braking and the determined braking capability of the execution module associated with braking.

In an embodiment, the hydraulic braking module is instructed, in response to the received status indication of the execution module associated with braking, to be in the normal state to perform braking using negative motor torque, where hydraulic braking torque is used for the braking when the negative motor torque is insufficient. In another embodiment, the hydraulic braking module is instructed, in response to the received status indication of the execution module associated with braking, to be in the degraded state (for example, a braking capability of the hydraulic braking module is lower than a preset braking capability threshold) to perform braking using hydraulic braking torque. It can be understood that when the hydraulic braking torque used for braking is insufficient, the hydraulic braking module reports a fault to a vehicle control unit, such that the vehicle control unit can deal with the situation that the hydraulic braking torque is insufficient in a timely manner. In still another embodiment, the hydraulic braking module is instructed, in response to the received status indication of the execution module associated with braking, to be in the failure state to perform braking using negative motor torque, where dynamic clamping braking torque is used for the braking when the negative motor torque is insufficient. It can be understood that when the dynamic clamping braking torque used for braking is insufficient, the dynamic clamping function module reports a fault to a vehicle control unit, such that the vehicle control unit can deal with the situation that the dynamic clamping braking torque is insufficient in a timely manner.

In an embodiment, various braking lines in a braking system (for example, a negative motor torque braking line, a hydraulic braking line, and a dynamic clamping braking line) are configured to perform braking control separately in response to receiving the assigned braking command, such that braking force can be ensured not to be lost under the states of the hydraulic braking module, thereby improving the safety and flexibility of the braking system.

Braking commands in the autonomous driving function are assigned, based at least in part on the status indication of the execution module associated with braking and the braking capability of the execution module associated with braking, according to the priority described in step 105 above, so that additional braking redundancy can be provided when an autonomous vehicle is braked, thereby improving the safety of the braking system. In addition, the braking lines (for example, the negative motor torque braking line, the hydraulic braking line, and the dynamic clamping braking line) in the braking system can be controlled completely independently of each other, thereby further improving the flexibility and safety of the braking system.

Optionally, vehicle stability control may be performed based at least in part on the received status indication of the execution module associated with braking (not shown in FIG. 1). In an embodiment, the hydraulic braking module is instructed, in response to the received status indication of the execution module associated with braking, to be in the normal state to control hydraulic braking torque and negative motor torque using the function module (for example, using an ABS module) associated with stability control in the hydraulic braking module, so as to prevent vehicle wheels from being locked. In another embodiment, the hydraulic braking module is instructed, in response to the received status indication of the execution module associated with braking, to be in the degraded state (for example, a braking capability of the hydraulic braking module is lower than a preset braking capability threshold) to control hydraulic braking torque using the function module (for example, using an ABS module in a vehicle control unit) associated with stability control in the vehicle control unit, so as to prevent vehicle wheels from being locked. In still another embodiment, the hydraulic braking module is instructed, in response to the received status indication of the execution module associated with braking, to be in the failure state to control negative motor torque and an anti-lock sub-module in an electronic parking module using the function module (for example, using a DTC module in a vehicle control unit) associated with stability control in the vehicle control unit, so as to prevent vehicle wheels from being locked.

According to the control method for braking backup in autonomous driving proposed in an aspect of the disclosure, additional braking redundancy can be provided for an autonomous vehicle when the autonomous vehicle is braked, braking stability can be ensured, and a braking failure rate can be reduced, thereby improving safety performance of a braking system in autonomous driving.

FIG. 2 is a schematic diagram of a control system for braking backup in autonomous driving according to an embodiment of the disclosure.

As shown in FIG. 2, the control system 200 for braking backup in autonomous driving includes a receiving unit 210, a determining unit 220, and an assignment unit 230.

The receiving unit 210 is configured to receive a status indication of an execution module associated with braking and a status indication of a function module associated with stability control.

In an embodiment, the status indication of the execution module associated with braking may include, but is not limited to, a motor status indication, a braking torque status indication, and an electronic parking status indication, where the motor status indication, the braking torque status indication, and the electronic parking status indication may indicate whether the corresponding execution module associated with braking is in a normal state, a degraded state, or a failure state. In an embodiment, the status indication of the function module associated with stability control may include, but is not limited to, an anti-lock (ABS) module status indication, a dragging torque control (DTC) module status indication, and a dynamic clamping (RWU) function module status indication, where the anti-lock (ABS) module status indication, the dragging torque control (DTC) module status indication, and the dynamic clamping (RWU) function module status indication may indicate whether the corresponding function module associated with stability control is in a normal state, a degraded state, or a failure state. It can be understood that the status indication of the execution module associated with braking and the status indication of the function module associated with stability control above may be respectively reported by the execution module associated with braking and the function module associated with stability control periodically to represent respective states thereof.

In an embodiment, the receiving unit 210 is configured to receive the status indication of the execution module associated with braking, the status indication of the function module associated with stability control, and status indications of various sensors in autonomous driving, so that the determining unit 220 determines whether the execution module associated with braking, the function module associated with stability control, and the various sensors in autonomous driving are available. As an example, the sensors may include, but are not limited to, a wheel speed sensor, an inertial sensor, a pressure sensor, a motor wheel speed sensor, an actual motor torque estimation module, and a battery charging limit estimation module.

The determining unit 220 is configured to determine a braking capability of the execution module associated with braking based at least in part on the received status indication of the execution module associated with braking and the received status indication of the function module associated with stability control, where the determined braking capability of the execution module associated with braking includes, but is not limited to, a hydraulic braking torque capability, a negative motor torque capability, and dynamic clamping braking torque.

The assignment unit 230 is configured to assign a braking command based at least in part on the received status indication of the execution module associated with braking and the determined braking capability of the execution module associated with braking.

In an embodiment, the assignment unit 230 is configured to instruct, in response to the received status indication of the execution module associated with braking, the hydraulic braking module to be in the normal state to perform braking using negative motor torque, where hydraulic braking torque is used for the braking when the negative motor torque is insufficient. In another embodiment, the assignment unit 230 is configured to instruct, in response to the received status indication of the execution module associated with braking, the hydraulic braking module to be in the degraded state (for example, a braking capability of the hydraulic braking module is lower than a preset braking capability threshold) to perform braking using hydraulic braking torque. It can be understood that when the hydraulic braking torque used for braking is insufficient, the hydraulic braking module reports a fault to a vehicle control unit, such that the vehicle control unit can deal with the situation that the hydraulic braking torque is insufficient in a timely manner. In still another embodiment, the assignment unit 230 is configured to instruct, in response to the received status indication of the execution module associated with braking, the hydraulic braking module to be in the failure state to perform braking using negative motor torque, where dynamic clamping braking torque is used for the braking when the negative motor torque is insufficient. It can be understood that when the dynamic clamping braking torque used for braking is insufficient, the dynamic clamping function module reports a fault to a vehicle control unit, such that the vehicle control unit can deal with the situation that the dynamic clamping braking torque is insufficient in a timely manner.

In an embodiment, various braking lines in a braking system (for example, a negative motor torque braking line, a hydraulic braking line, and a dynamic clamping braking line) are configured to perform braking control separately in response to receiving the braking command assigned by the assignment unit 230, such that braking force can be ensured not to be lost under states of the hydraulic braking module, thereby improving the safety and flexibility of the braking system.

The assignment unit 230 is configured to assign, based at least in part on the status indication of the execution module associated with braking and the braking capability of the execution module associated with braking, braking commands in the autonomous driving function according to the priority described above, so that additional braking redundancy can be provided when an autonomous vehicle is braked, thereby improving the safety of the braking system. In addition, the braking lines (for example, the negative motor torque braking line, the hydraulic braking line, and the dynamic clamping braking line) in the braking system can be controlled completely independently of each other, thereby further improving the flexibility and safety of the braking system.

Optionally, the control system 200 for braking backup in autonomous driving may further include a stability control unit (not shown in FIG. 2), where the stability control unit is configured to perform vehicle stability control based at least in part on the received status indication of the execution module associated with braking. In an embodiment, the stability control unit is configured to instruct, in response to the received status indication of the execution module associated with braking, the hydraulic braking module to be in the normal state to control hydraulic braking torque and negative motor torque using the function module (for example, using an ABS module) associated with stability control in the hydraulic braking module, so as to prevent vehicle wheels from being locked. In another embodiment, the stability control unit is configured to instruct, in response to the received status indication of the execution module associated with braking, the hydraulic braking module to be in the degraded state (for example, a braking capability of the hydraulic braking module is lower than a preset braking capability threshold) to control hydraulic braking torque using the function module (for example, using an ABS module in a vehicle control unit) associated with stability control in the vehicle control unit, so as to prevent vehicle wheels from being locked. In still another embodiment, the stability control unit is configured to instruct, in response to the received status indication of the execution module associated with braking, the hydraulic braking module to be in the failure state to control negative motor torque and an anti-lock sub-module in an electronic parking module using the function module (for example, using a DTC module in a vehicle control unit) associated with stability control in the vehicle control unit, so as to prevent vehicle wheels from being locked.

According to the control system for braking backup in autonomous driving proposed in an aspect of the disclosure, additional braking redundancy can be provided for an autonomous vehicle when the autonomous vehicle is braked, braking stability can be ensured, and a braking failure rate can be reduced, thereby improving safety performance of a braking system in autonomous driving.

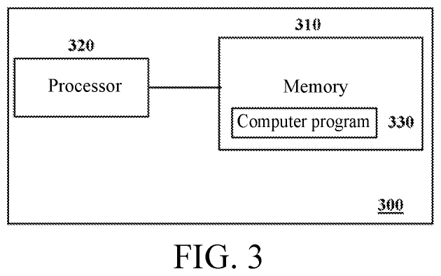

FIG. 3 is a block diagram of a computer device according to an embodiment of the disclosure. As shown in FIG. 3, a computer device 300 includes a memory 310, a processor 320, and a computer program 330 stored on the memory 310 and executable on the processor 320. The processor 320, when executing the computer program 330, implements the steps of the control method for braking backup in autonomous driving according to an aspect of the disclosure, for example, as shown in FIG. 1.

In addition, as described above, the disclosure may also be implemented as a computer storage medium, which has stored therein a program for causing a computer to perform the control method for braking backup in autonomous driving according to an aspect of the disclosure.

Here, various forms of computer storage media, such as disks (for example, a magnetic disk, an optical disc, etc.), cards (for example, a memory card, an optical card, etc.), semiconductor memories (for example, a ROM, a non-volatile memory, etc.), and tapes (for example, a magnetic tape, a cassette tape, etc.) may be used as the computer storage medium.

Various embodiments provided in the disclosure may be implemented by hardware, software, or a combination of hardware and software where applicable. In addition, without departing from the scope of the disclosure, various hardware components and/or software components described in this specification may be combined into a combined component including software, hardware, and/or both where applicable. Without departing from the scope of the disclosure, various hardware components and/or software components described in this specification may be separated into sub-components including software, hardware, or both where applicable. In addition, where applicable, it is contemplated that software components may be implemented as hardware components, and vice versa.

Software (such as program code and/or data) in the disclosure may be stored on one or more computer storage media. It is also contemplated that the software identified herein may be implemented using one or more general-purpose or special-purpose computers and/or computer systems, networked and/or otherwise. The steps described herein may be changed in order, combined into compound steps, and/or divided into sub-steps where applicable, to provide the features described herein.

The embodiments and examples proposed herein are provided to describe as adequately as possible embodiments according to the disclosure and specific applications thereof and thus enable those skilled in the art to implement and use the disclosure. However, those skilled in the art will know that the above descriptions and examples are provided only for description and illustration. The proposed description is not intended to cover all aspects of the disclosure or limit the disclosure to the disclosed precise forms.

What is claimed is:

1. A control method for braking backup in autonomous driving, comprising:
receiving a status indication of an execution module associated with braking and a status indication of a function module associated with stability control;
determining, based at least in part on the received status indication of the execution module associated with braking and the received status indication of the function module associated with stability control, a braking capability of the execution module associated with braking; and
assigning a braking command based at least in part on the received status indication of the execution module associated with braking and the determined braking capability of the execution module associated with braking.

2. The method according to claim 1, further comprising:
performing vehicle stability control based at least in part on the received status indication of the execution module associated with braking.

3. The method according to claim 1, wherein the execution module associated with braking comprises one or more of the following: a hydraulic braking module, a motor torque response module, and an electronic parking module.

4. The method according to claim 3, wherein the determined braking capability of the execution module associated with braking comprises one or more of the following: a hydraulic braking torque capability, a negative motor torque capability, and dynamic clamping braking torque.

5. The method according to claim 4, wherein the assigning the braking command based at least in part on the received status indication of the execution module associated with braking and the determined braking capability of the execution module associated with braking further comprises:
instructing, in response to the received status indication of the execution module associated with braking, the hydraulic braking module to be in a first state to perform braking using negative motor torque, wherein hydraulic braking torque is used for the braking when the negative motor torque is insufficient.

6. The method according to claim 4, wherein the assigning the braking command based at least in part on the received status indication of the execution module associated with braking and the determined braking capability of the execution module associated with braking further comprises:
instructing, in response to the received status indication of the execution module associated with braking, the hydraulic braking module to be in a second state to perform braking using hydraulic braking torque.

7. The method according to claim 4, wherein the assigning the braking command based at least in part on the received status indication of the execution module associated with braking and the determined braking capability of the execution module associated with braking further comprises:
instructing, in response to the received status indication of the execution module associated with braking, the hydraulic braking module to be in a third state to perform braking using negative motor torque, wherein dynamic clamping braking torque is used for the braking when the negative motor torque is insufficient.

8. The method according to claim 2, wherein the performing vehicle stability control based at least in part on the received status indication of the execution module associated with braking further comprises:
instructing, in response to the received status indication of the execution module associated with braking, a hydraulic braking module to be in a first state to control hydraulic braking torque and negative motor torque using the function module associated with stability control in the hydraulic braking module.

9. The method according to claim 2, wherein the performing vehicle stability control based at least in part on the received status indication of the execution module associated with braking further comprises:
instructing, in response to the received status indication of the execution module associated with braking, a hydraulic braking module to be in a second state to control hydraulic braking torque using the function module associated with stability control in a vehicle control unit.

10. The method according to claim 2, wherein the performing vehicle stability control based at least in part on the received status indication of the execution module associated with braking further comprises:
instructing, in response to the received status indication of the execution module associated with braking, a hydraulic braking module to be in a third state to control negative motor torque and an anti-lock sub-module in an electronic parking module using the function module associated with stability control in a vehicle control unit.

11. A control system for braking backup in autonomous driving, comprising:
a receiving unit configured to receive a status indication of an execution module associated with braking and a status indication of a function module associated with stability control;
a determining unit configured to determine, based at least in part on the received status indication of the execution module associated with braking and the received status indication of the function module associated with stability control, a braking capability of the execution module associated with braking; and
an assignment unit configured to assign a braking command based at least in part on the received status indication of the execution module associated with braking and the determined braking capability of the execution module associated with braking.

12. The system according to claim 11, further comprising:
a stability control unit configured to perform vehicle stability control based at least in part on the received status indication of the execution module associated with braking.

13. The system according to claim 11, wherein the assignment unit is further configured to:
instruct, in response to the received status indication of the execution module associated with braking, a hydraulic braking module to be in a first state to perform braking using negative motor torque, wherein hydraulic braking torque is used for the braking when the negative motor torque is insufficient.

14. The system according to claim 11, wherein the assignment unit is further configured to:
instruct, in response to the received status indication of the execution module associated with braking, a hydraulic braking module to be in a second state to perform braking using hydraulic braking torque.

15. The system according to claim 11, wherein the assignment unit is further configured to:
instruct, in response to the received status indication of the execution module associated with braking, a hydraulic braking module to be in a third state to perform braking using negative motor torque, where dynamic clamping braking torque is used for the braking when the negative motor torque is insufficient.

16. The system according to claim 12, wherein the stability control unit is further configured to:
instruct, in response to the received status indication of the execution module associated with braking, a hydraulic braking module to be in a first state to control hydraulic braking torque and negative motor torque using the function module associated with stability control in the hydraulic braking module.

17. The system according to claim 12, wherein the stability control unit is further configured to:
instruct, in response to the received status indication of the execution module associated with braking, a hydraulic braking module to be in a second state to control hydraulic braking torque using the function module associated with stability control in a vehicle control unit.

18. The system according to claim 12, wherein the stability control unit is further configured to:
instruct, in response to the received status indication of the execution module associated with braking, a hydraulic braking module to be in a third state to control negative motor torque and an anti-lock sub-module in an electronic parking module using the function module associated with stability control in a vehicle control unit.

19. A computer storage medium comprising instructions, wherein when the instructions are run, the method according to claim 1 is performed.

20. A computer device, comprising: a memory, a processor, and a computer program stored on the memory and executable on the processor, wherein when the processor executes the computer program, the method according to claim 1 is performed.

21. A vehicle, comprising the control system for braking backup in autonomous driving according to claim 11.
